(19) United States
(12) Patent Application Publication
(10) Pub. No.: US 2025/0224255 A1
(43) Pub. Date: Jul. 10, 2025

(54) METHOD FOR ALIGNMENT CALIBRATION OF AN INERTIAL MEASUREMENT UNIT IN A HEAD-WORN APPARATUS

(71) Applicant: Robert Bosch GmbH, Stuttgart (DE)

(72) Inventors: Ye Lu, Walddorfaeslach (DE); Hu Wu, Hoehenkirchen-Siegertsbrunn (DE); Kejia Wang, Korntal-Muenchingen (DE); Sreepad Sudhakaran, Reutlingen-Kusterdingen (DE); Ivan Flores Delgado, Stuttgart (DE)

(21) Appl. No.: 18/987,637

(22) Filed: Dec. 19, 2024

(30) Foreign Application Priority Data
Jan. 8, 2024 (DE) 10 2024 200 158.9
Jan. 9, 2024 (DE) 10 2024 200 172.4

(51) Int. Cl. G01C 25/00; H04R 1/10; H04R 29/00

(52) U.S. Cl. CPC G01C 25/005; H04R 1/1016; H04R 29/001

(57) ABSTRACT

A method for alignment calibration of an inertial measurement unit contained in a head-worn apparatus. The method includes: wearing an apparatus on the head of a user; performing a static calibration stage including determining a misalignment of a first sensitive axis of the inertial measurement unit with respect to a direction of gravity while the user holds their head statically, looks straight ahead and horizontally.

### CROSS REFERENCE

The present application claims the benefit under 35 U.S.C. § 119 of German Patent Application Nos. DE 10 2024 200 158.9 filed on Jan. 8, 2024, and DE 10 2024 200 172.4 filed on Jan. 9, 2024, which are both expressly incorporated herein by reference in their entireties.

### BACKGROUND INFORMATION

Today, there is a growing trend for head-worn apparatuses, such as in-ear headphones, over-ear headphones, smart glasses, and AR/VR headsets, to be equipped with integrated inertial MEMS (micro-electromechanical system) sensors, such as accelerometers and gyroscopes, in order to help determine the alignment of a head. This makes possible various advanced applications such as head tracking, spatial audio, head gesture detection, human-machine interaction, and pedestrian navigation.

Typically, the alignment of the head is described in the head coordinate system, while the raw sensor data are provided in the body coordinate system or in the sensor coordinate system. In order to transform the information from the sensor coordinate system to the head coordinate system, the alignment offset or the rotation or the “misalignment” between the two coordinate systems must be accurately determined, see the representation in FIG. 1.

The misalignment between the two coordinate systems differs from user to user due to different head sizes (which in particular affects over-ear headphones) or ear shapes (especially for in-ear headphones). Users can also wear the apparatus with a slightly different alignment or position each time. These cases further complicate the estimation of the misalignment. Calibration for this misalignment is required.

For head tracking with integrated sensors, different approaches are conventional in the field with regard to the alignment of the head and sensor coordinate systems.

U.S. Patent Application No. US 2023/0143987 A1 describes the idea of using in-ear headphones for head gesture detection. The two in-ear headphones collect accelerometer data in a reference frame linked to the in-ear headphones. The raw data are then rotated into a neutral reference frame with a fixed alignment to the Earth using a rotation matrix. In order to calculate or update the rotation matrix, a rest period is required, during which the user does not move significantly, in order to determine average accelerometer values. The data in the neutral reference frame can be analyzed in order to categorize the user head positions using a head pose lookup table.

U.S. Pat. No. 9,237,393 B2 describes a method for determining direction and user head motion by means of a headset with accelerometers. A pair of in-ear headphones integrated with accelerometers provides the acceleration information used to detect the direction of gravity (to determine a horizontal plane), and the signals from left and right accelerometers are then used to remove non-horizontal motion and determine the angular motion of the user's head in a generally horizontal plane.

U.S. Pat. Nos. 8,644,531 BB and 9,950,239 BA contribute to the subject matter of determining a head position with respect to gravity but do not show the details of the method. U.S. Patent Application No. US 2014/254817 AA and US 2018/091924 AA disclose how the head alignment is determined based on the comparison between two accelerometer signals or from the position of two in-ear headphones.

In all methods mentioned, some of them obtain the head alignment information in one direction, such as gaze direction or yaw motion. Other approaches require at least two sensors to be integrated into a pair of in-ear headphones, in order to obtain partial alignment information. There are also products on the market, such as the Sony WF-1000XM5 wireless in-ear headphones, which support a head-tracking function. However, these products require a specific 3-stage calibration procedure for obtaining the head alignment information.

### SUMMARY

An object of the present invention is to efficiently align the head and sensor coordinate systems in a quick and user-friendly manner so that head alignment is accurately tracked in use, but also with a reduced need for user intervention compared to prior-art methods.

The present invention relates to a method for alignment calibration of an inertial measurement unit contained in a head-worn apparatus. According to an example embodiment of the present invention, the method comprises the following steps:
(A)—Wearing an apparatus on the head of a user;
(B)—Performing a static calibration stage comprising determining a misalignment of a first sensitive axis of the inertial measurement unit with respect to a direction of gravity while the user holds their head statically, looks straight ahead and horizontally.

An advantageous example of the present invention provides that, in a step (C), a dynamic calibration stage is performed, comprising determining a misalignment of a second sensitive axis of the inertial measurement unit while the user tilts their head left and right or nods their head up and down.

A further advantageous example of the present invention provides that, in a step (C), a mathematical correction of a misalignment of a second sensitive axis of the inertial measurement unit is performed, using apparatus-specific alignment information.

It is in particular advantageous that apparatus-specific alignment information for the static calibration stage is provided in step (B), and updated apparatus-specific alignment information for step (C) is provided as a result of step (B).

According to an example embodiment of the present invention, in order to overcome the limitations of the above-mentioned existing methods, it is provided that this semi-automatic calibration method estimates the three-dimensional misalignment information using a 6-axis IMU consisting of a 3-axis accelerometer and a 3-axis gyroscope. With this method, the user only needs to hold their head still and look straight ahead for a short period of time, after which the system resolves any misalignment information and eliminates the need for further head motions during the calibration. Since only a minimal routine needs to be performed by the user, this novel method is referred to as semi-automatic misalignment calibration. This method offers a plurality of advantages, including: The alignment of the head is precisely maintained in all three directions, i.e., gaze direction, pitch and roll. No specific or complex head motion is required of the user. No signal synchronization between two sensors is necessary since only one sensor is required. The gyroscope provides highly accurate alignment even under dynamic conditions.

The main idea behind the semi-automatic calibration invention is to allow an end user of a head-worn apparatus with a head alignment tracking feature (e.g., in the context of 3D audio, AR/VR or a human-machine interaction) to calibrate the system by simply holding the head still for a short period of time. No further head motions are necessary to align other axes in the system. Rather than relying on further head motions, the approximate or partial knowledge of the sensor placement inside the apparatus is used to provide a predefined input. In our implementation example, this is a vector, hereafter referred to as “VectorX,” which is then used in calculations to complete the full misalignment calibration between the sensor and head coordinate systems.

This approach of the present invention improves the user experience since less end-user interaction is necessary, which provides a more user-friendly plug-and-play or out-of-the-box experience. The present invention requires some initial knowledge of the approximate sensor alignment in the head-worn design. This knowledge can be obtained from the apparatus characteristics. This information is used to derive a technical numerical setting, VectorX, that is sufficiently precise.

### BRIEF DESCRIPTION OF THE DRAWINGS

FIG. 1 schematically shows the misalignment between the head and sensor coordinate systems.

FIG. 2 shows a flowchart of a two-stage misalignment calibration method, which comprises a static part and a head nodding motion.

FIG. 3 shows a head and over-ear headphones with their corresponding coordinate systems.

FIG. 4 shows a flowchart of a one-stage misalignment calibration method that comprises a static part and a mathematical correction.

FIGS. 5A, 5B, and 5C show the update of the apparatus-specific alignment “VectorX” resulting from the one-stage misalignment calibration.

FIG. 6 schematically shows the method for an alignment calibration of an inertial measurement unit in a head-worn apparatus according to the present invention.

### DETAILED DESCRIPTION OF EXAMPLE EMBODIMENTS

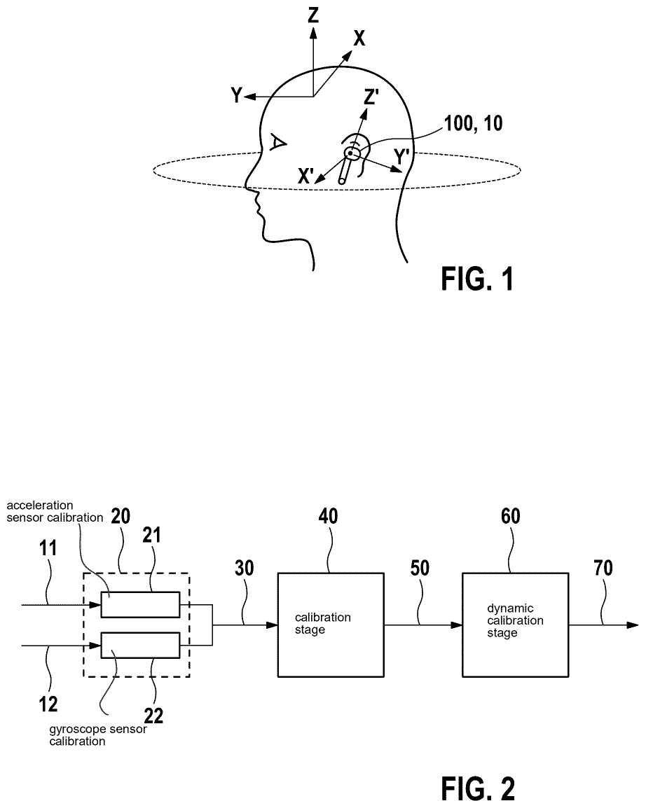

FIG. 1 schematically shows the misalignment between the head and sensor coordinate systems. A coordinate system X, Y, Z is assigned to a head. A head-worn apparatus, here in-ear headphones 100, comprises an inertial measurement unit (IMU) 10, which has 3 sensitive axes defining a coordinate system X′, Y′, Z′.

Typically, the alignment of the head is described in a head coordinate system, while the raw sensor data of an inertial measurement unit (IMU) are provided in a body coordinate system or a sensor coordinate system. In order to transform the information from the sensor coordinate system into the head coordinate system, the alignment offset or “misalignment” between the two coordinate systems must be determined precisely.

The misalignment between the two coordinate systems differs from user to user due to different head sizes (which in particular affects over-ear headphones) or ear shapes (especially for in-ear headphones). Users can also wear the apparatus with a slightly different alignment or position each time. These cases further complicate the estimation of the misalignment. The sensor and head coordinate systems described here are right-handed systems.

The head coordinate system is defined as:
X-axis: points from the left ear to the right ear.
Y-axis: points from the center of the head to the nose.
Z-axis: points upward from the center of the head.

This Cartesian coordinate system forms a right-handed system with an X-Y plane.

For head tracking with head-worn inertial sensors, an alignment of the head coordinate system and the sensor coordinate system is a prerequisite.

FIG. 2 shows a flowchart of a two-stage misalignment calibration method, which comprises a static part and a head nodding motion.

Raw acceleration data 11 and raw rotation rate data 12 are fed into a sensor calibration 20. The sensor calibration comprises an acceleration sensor calibrator 21 and a gyroscope sensor calibrator 22. Calibrated sensor data 30 are fed into the static calibration stage 40. In this static calibration stage, tilt correction is made possible by holding the head still and looking straight ahead. Updated angular rates 50 are fed into a dynamic calibration stage 60. In this dynamic calibration stage, a correction of the gaze direction is performed by nodding the head up and down. A misalignment correction quaternion 70 is provided as an output.

This two-stage calibration method comprises a first static stage and a second dynamic stage of user interaction and is an improved version of the method disclosed in Germany Patent Application No. DE 10 2020 208 283 A1.

Since both the head coordinate system and the sensor coordinate system are right-handed 3D systems, at least two of the three axes must be aligned in order to achieve complete alignment of both systems. The first step involves the use of the gravity information for aligning the Z-axis. If the user keeps their head static, looks straight ahead and horizontally, the Z-axis is aligned with the Earth's gravity vector. Under this condition, the accelerometer data (measurements of the gravity vector) can be used to calculate the tilt of the sensor, i.e., the pitch and roll alignment of the apparatus. It is recommended that the user hold their head in this state for a few seconds so that the average of the accelerometer data can provide a good estimate of the tilt. The Z-axes are then aligned by performing the tilt correction, i.e., reversing the rotation with the calculated pitch and roll angle. The correction is calculated as a quaternion since a rotation quaternion is used for representing the alignment.

There are different methods for aligning the second axis. One approach is to find the angle between X-axes or Y-axes of two systems by performing specific head motions, such as nodding the head up and down or tilting the head left and right. During motion, such as nodding, the angular rates provided by the gyroscope should be mainly around the X-axis of the head, and the angular rates around the Y-axis should be close to zero. If the head is tilted left and right, the angular rates should be mainly around the Y-axis of the head, and those around the X-axis should be close to zero.

By applying the tilt correction quaternion obtained from the first step to the gyroscope raw data, the updated angular rates can be used to estimate the angle between X-axes or Y-axes, i.e., the correction of the gaze direction. This step is referred to in this report as dynamic calibration. Thereafter, the complete misalignment correction quaternion can be calculated by multiplying the correction quaternions obtained from the two steps. The flowchart of this two-stage calibration is shown in FIG. 2, which also comprises the optional sensor calibration block 20 (the detailed description is given in the next section).

The two-stage calibration method offers a plurality of advantages, as a result of which it becomes apparatus-independent and user-independent and works every time. For any type of head-worn apparatus with an integrated 6-axis IMU, i.e., in-ear headphones and over-ear headphones, users can obtain the misalignment correction quaternion for their own case by triggering this calibration.

The correction quaternion is specific to the user's use case, i.e., the effects of the user's different head size and ear shape are already included in the correction quaternion. In addition, calibration can be triggered each time the user wears the apparatus, in order to obtain the precise correction quaternion, regardless of whether the user is wearing the apparatus. All these characteristics improve the robustness, reliability and stability of this method under all circumstances.

The two-stage calibration method, although functional, may not be considered user-friendly. Users must follow specific instructions for appropriate head motions. This could degrade the user experience when trying the head tracking feature, in particular if a plug-and-play apparatus is desired. In order to overcome this problem, the present invention uses a novel method, which is called the semi-automatic calibration approach, in order to simplify the calibration procedure and minimize the effort for the user.

In general, the semi-automatic approach only requires the static step of two-stage calibration. The dynamic calibration is replaced by a mathematical correction that is carried out based on assumptions and hardware design information.

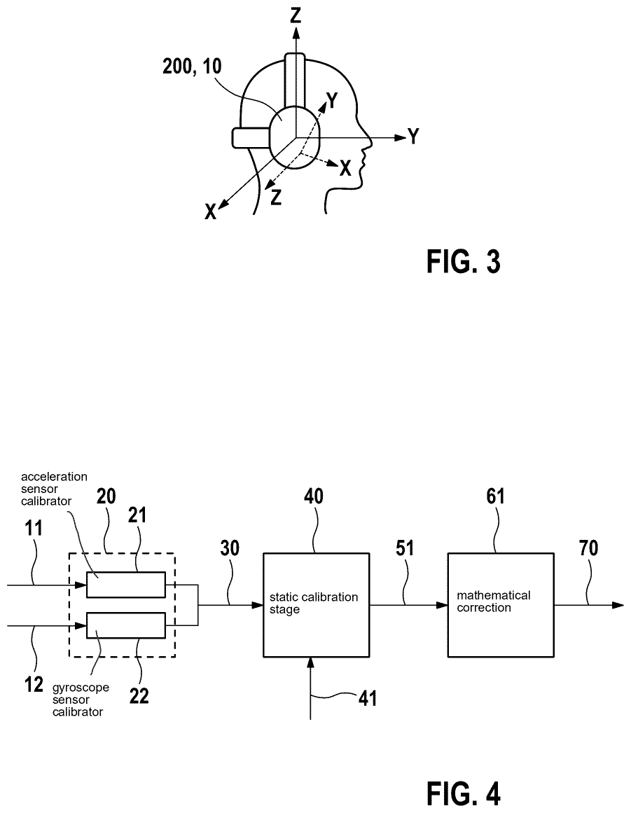

For many head-worn apparatuses, such as over-the-ear headphones, users primarily adjust the headphones rotationally about the X-axis of the head (see FIG. 3), with minimal rotation about the other two axes. This means that the X-axis of the head can be viewed in a fixed direction in the sensor coordinate system so that it can be described as a known vector, namely as VectorX. This advance information can be used to implement a mathematical correction in order to align the second axis after the alignment of the Z-axes.

FIG. 3 shows an example of a head and over-ear headphones with their corresponding coordinate systems. It shows over-ear headphones 200 in which the X-axis of the head is probably in a fixed direction in the apparatus or the sensor unit 10. As an example, the X-axis of the head (solid line) is aligned with the Z-axis of the sensor (dashed line), which is an inertial measurement unit contained in the over-ear headphones.

FIG. 4 shows a flowchart of a one-stage misalignment calibration method that comprises a static part and a mathematical correction.

Raw acceleration data 11 and raw rotation rate data 12 are fed into a sensor calibration 20. The sensor calibration comprises an acceleration sensor calibrator 21 and a gyroscope sensor calibrator 22. Calibrated sensor data 30 are fed into the static calibration stage 40. In addition, apparatus-specific alignment information 41, which is VectorX, is fed into the static calibration stage. In this static calibration stage, tilt correction is made possible by holding the head still and looking straight ahead. Updated specific alignment information 51, which is the updated VectorX, is generated and provided for a mathematical correction 61. In this dynamic calibration stage, a correction of the gaze direction is performed by nodding the head up and down. A misalignment correction quaternion 70 is provided as an output.

This one-stage calibration method comprises only a single static phase of user interaction and a mathematical correction that is performed automatically. Therefore, this method generates a semi-automatic misalignment calibrator for estimating a misalignment quaternion.

In order to achieve optimal head tracking performance, sensor calibrations for the accelerometer and gyroscope are also included in the figure (but are optional). The accelerations can, for example, be corrected by means of a 6-position calibrator, which estimates the offsets and sensitivities in all three axes. For other, less sophisticated applications, a simple accelerometer calibrator can also fulfill the minimum requirements. Gyroscope offset calibration is highly recommended for head tracking since the alignment error accumulates over time during the integration of the angular rate. Gyroscope offset calibration is simple. If the apparatus is in a static state for a few seconds, the offsets of the gyroscope can be estimated from the raw angular rates. The concept of sensor offset calibration is not directly related to the misalignment calibration algorithms, but they are recommended for head tracking and similar applications.

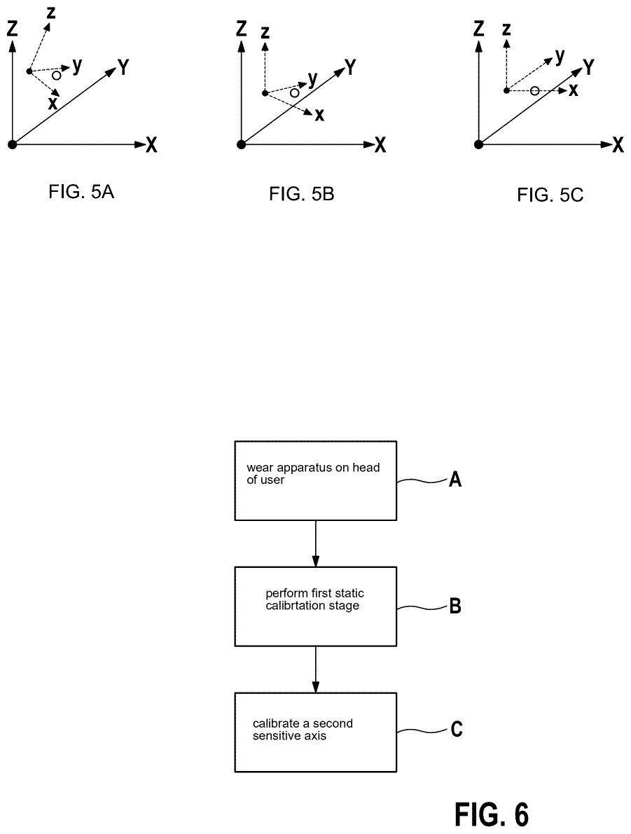

FIGS. 5A, 5B, and 5C show the update of the apparatus-specific alignment “VectorX” resulting from the one-stage misalignment calibration. A head coordinate system (solid line) and a sensor coordinate system (dashed line) are shown. The apparatus-specific alignment vector is marked with a circle.

FIG. 5A shows an initial phase with completely misaligned head and sensor coordinate systems.

FIG. 5B shows head and sensor coordinate systems with aligned Z-axis. FIG. 5C shows fully aligned head and sensor coordinate systems.

Just as in the first step of the two-stage calibration, the Z-axes are first aligned between two reference systems. The user must hold their head statically for a few seconds and look straight ahead (keep the line of sight horizontal). The average of accelerations (i.e., gravity vectors) is used to calculate the tilt (pitch and roll) of the sensor. The intermediate misalignment correction quaternion q₁ is obtained by reversing the rotation with the pitch and roll. VectorX (v) should also be updated in the intermediate reference frame, see FIGS. 5A, 5B, 5C, by:

vᵢ=q₁vq*ᵢ

The X-axis of the head can be described by the unit vector v_{f}, with the value as [1; 0; 0]. The angle θ between the X-axis of the head and that of the intermediate system can be calculated from these two vectors:

$$θ = a cos ( \frac{{v}_{i} \cdot {v}_{f}}{\vert {v}_{i} \vert \vert {v}_{f} \vert} )$$

If both vᵢ and v_{f} are unit vectors, the estimation of θ can be simplified as

θ=a tan 2(vᵢ^{y},vᵢ^{x})

Based on the axis-angle representation, the correction quaternion can be written as

$${q}_{2} = [ cos \frac{θ}{2} , 0 , 0 , sin \frac{θ}{2} ]$$

The final correction quaternion q is calculated as

q=q₂q₁

Configuration of the Apparatus-Specific Alignment Information—VectorX

It is recommended to obtain the optimal VectorX by re-mapping the X-axis of the head into the sensor system in the final design stage for the apparatus. This is the ideal approach for the apparatus manufacturer (e.g., headphone designer) in order to obtain the most accurate VectorX for their own product. For some apparatuses, such as over-ear headphone products that have the printed circuit board (PCB) where the IMU sensor is integrated into the center of the ear pad, the printed circuit board (sensor board) is perpendicular to the X-axis of the head. This means that the X-axis of the head is almost aligned with the Z-axis of the sensor (since the Z-axis of the sensor is out of the plane perpendicular to the printed circuit board), see FIG. 3, so that VectorX can be approximated as [0; 0; 1] or [0; 0; −1]. Based on the data-driven evaluation, the semi-automatic calibration can achieve an accuracy of within 5 degrees with this approximation, which fulfills the requirements for many applications (e.g., most general spatial audio applications).

The semi-automatic calibration method was evaluated using different configurations (real products and over-ear headphones with attached experimental sensor boards) as well as different users. It has been shown that this method can achieve a performance comparable to two-stage calibration if VectorX is configured with two decimal places. Furthermore, a further advantage compared to the two-stage calibration is that the semi-automatic approach shows a lower variance of the correction quaternions from different users/testers since the deviations from the dynamic calibration stage are filtered out. Therefore, if the user can provide a good estimate of VectorX for their head-worn apparatus, the semi-automatic approach can serve as a highly user-friendly solution in order to obtain the precise misalignment information between the head and sensor coordinate systems.

The semi-automatic approach can potentially also be used for in-ear headphones. However, it is important to ensure that the assumptions made for the semi-automatic approach are also fulfilled for the in-ear headphones. From a design point of view, it is possible to keep the sensor board of in-ear headphones perpendicular to the X-axis of the head or parallel to the Z-axis of the head.

FIG. 6 schematically shows an example of the method for an alignment calibration of an inertial measurement unit in a head-worn apparatus according to the present invention. The method comprises the following steps:
(A)—Wearing the apparatus on the head of a user.
(B)—Performing a first static calibration stage comprising determining a misalignment of a first sensitive axis of the inertial measurement unit with respect to a direction of gravity while the user holds their head statically, looks straight ahead and horizontally.

(C)—Calibrating a second sensitive axis of the inertial measurement unit, which can be carried out either by means of a second, dynamic calibration stage or by means of a mathematical correction using apparatus-specific alignment information.

What is claimed is:

1. A method for alignment calibration of an inertial measurement unit contained in a head-worn apparatus. The method including:
(A) wearing an apparatus on a head of a user;
(B) performing a static calibration stage including determining a misalignment of a first sensitive axis of the inertial measurement unit with respect to a direction of gravity while the user holds their head statically, looks straight ahead, and horizontally.

2. The method for calibrating an inertial measurement unit according to claim 1, further comprising:
(C) performing a dynamic calibration stage including determining a misalignment of a second sensitive axis of the inertial measurement unit while the user tilts their head to the left and/or right or the user nods their head up and/or down.

3. The method for calibrating an inertial measurement unit according to claim 1, further comprising:
(C) performing a mathematical correction of a misalignment of a second sensitive axis of the inertial measurement unit using apparatus-specific alignment information.

4. The method for calibrating an inertial measurement unit according to claim 3, wherein, in step (B), apparatus-specific alignment information is provided for the static calibration stage and, as a result of step (B), updated apparatus-specific alignment information is provided for step (C).
